(19) United States
(12) Patent Application Publication
(10) Pub. No.: US 2026/0287534 A1
(43) Pub. Date: Sep. 24, 2026

(54) Method and Device for Detecting a Critical Moisture Level within a Housing of an Active Module

(71) Applicant: Robert Bosch GmbH, Stuttgart (DE)

(72) Inventors: Norbert Pfitzke, Riederich (DE); Walter Gronbach, Kohlberg (DE)

(21) Appl. No.: 19/490,043

(22) PCT Filed: Jun. 4, 2024
(86) PCT No.: PCT/EP2024/065293

§ 371 Date: Dec. 4, 2025

(30) Foreign Application Priority Data
Jun. 7, 2023 (DE) 10 2023 205 318.7

(51) Int. Cl. G01N 25/68; G01D 21/02; G01M 3/00; G08B 21/20

(52) U.S. Cl. CPC G01N 25/68; G01D 21/02; G01M 3/002; G08B 21/20; G01W 2203/00

(57) ABSTRACT

A method for monitoring the moisture level inside a closed housing of an active module includes (i) after cold starting the active module, detecting a variation over time of a temperature and a moisture level of a gas inside the housing during a predetermined cold-starting phase, (ii) providing an ambient temperature at the time of the cold starting of the active module, and (iii) depending on the detected variations of the temperature and the moisture level and depending on the ambient temperature and with the aid of a data-based dew-point model provided, signaling an excessively high moisture level inside the housing, wherein the data-based dew-point model is trained such that, depending on the variations of the temperature and the moisture level, it will give a maximum dew-point temperature or, in particular depending on an ambient temperature at the beginning of the cold-starting phase, it will give an indication of a possible instance of the temperature being below a maximum dew-point temperature.

### TECHNICAL FIELD

The invention relates to methods for detecting a critical moisture level in a closed housing of an active module. The invention further relates to methods for avoiding condensation of components within the active module.

### TECHNICAL BACKGROUND

Active modules, such as electronic modules, e.g., control devices that operate outside of a supported environment, are typically encapsulated in a closed housing. The closed housings protect components of the active module, in particular electronic components, from dirt and moisture. The housings are typically closed with moisture-proof seals, so that in the normal case no additional moisture can enter the housing.

However, water or moisture may enter the inside of the housing due to damage, cracking due to aging of the housing material and the like. However, such an increase in the amount of moisture within the housing is not readily detected immediately, especially if the additional moisture that has penetrated only increases gradually and does not immediately lead to condensation of water on individual components and thus does not immediately cause a malfunction. For safety reasons, however, it is required to detect leaks in the housing and the ingress of moisture above a critical level as quickly as possible, in particular before a functional failure occurs. This is particularly essential when using such active modules, for example in the form of control devices, for steering and braking systems in vehicles.

It is the object of the present invention to provide a method for monitoring a moisture level present in a sealed housing of an active module, with which a critical level of moisture can be detected before actual condensation of individual components or condensation of water in the housing occurs.

### DISCLOSURE OF THE INVENTION

This object is solved by the method for monitoring a moisture level in a housing of an active module according to claim 1 as well as an active module in a closed housing according to the further independent claim.

Further embodiments are specified in the dependent claims.

According to a first aspect, a method for monitoring moisture inside a closed housing of an active module is provided, with the steps of:
after cold starting the active module, detecting a variation over time of a temperature and a moisture level of a gas inside the housing;
providing an ambient temperature at the time of cold starting of the active module;
depending on the detected variations of the temperature and the moisture level and depending on the ambient temperature and with the aid of a data-based dew-point model provided, signaling an excessively high moisture level inside the housing, wherein the data-based dew-point model is trained such that, depending on the variations of the temperature and the moisture level, it will give a maximum dew-point temperature or, furthermore depending on an ambient temperature at the beginning of the cold-starting phase, it will give an indication of a possible instance of the temperature being below a maximum dew-point temperature.

Further, signaling the excessively high of moisture inside the housing may comprise the steps of:
determining the modeled maximum dew-point temperature during the cold-starting phase based on the variations of the temperature and the moisture level with the aid of the trained data-based dew-point model;
signaling the excessively high of moisture inside the housing if the ambient temperature is below a threshold value determined depending on the maximum dew-point temperature.

When cold starting an encased active module, for example a control device, local heating of individual components within the housing usually occurs first. This results in moisture stored in the materials of the components being released and the absolute moisture level rising in the inner housing. However, the inner walls of the housing and, e.g., unpowered components are initially at ambient temperature, so that, depending on the extent of the increasing moisture level and temperature of the components that have not yet been heated, condensation of water can occur on the surfaces of the components that have not yet been heated. This can lead to functional impairments and destruction of the active module upon contact with, for example, live elements.

The ambient temperature can be provided as a temperature at the time of cold starting the active module by a temperature sensor inside or outside of the active module or as the first detected value of the temperature inside the housing.

To monitor the moisture level present in a housing, a temperature/moisture sensor, in particular as a combined sensor, may be provided that can be integrated into the electronics of the active device. The temperature/moisture level sensor makes it possible to detect the temperature and moisture level of the air present in the housing and to determine a dew-point temperature or absolute moisture level in the form of an amount of water vapor in the housing using known dew-point tables, which assign a moisture level and a temperature of air to a dew-point temperature. When moisture or water enters the housing, the content of water vapor inside the housing increases so that water can condense on components of the active device that are not yet heated.

The dew-point temperature corresponds to the temperature at which condensation of water in air occurs or below which condensation of water occurs on a surface at a temperature corresponding to the dew-point. The dew-point temperature may be determined using dew-point tables or according to a known mathematical model.

The determination of critical states inside the housing is not trivial, as plastics and other hygroscopic materials of components of the active module, for example, can release trapped or bound water into the air inside the housing when heated.

From the variation of the moisture level and the temperature of the gas (e.g., air) enclosed in the housing after cold starting (i.e., all components and the housing are substantially at ambient temperature), a dew-point temperature can now be determined at which condensation of water can or may take place on a component of the active module that has not yet been heated.

To monitor a critical moisture level inside the housing, the development or variation over time of the moisture level, i.e. the moisture level of the enclosed gas, and the temperature, i.e. the temperature of the enclosed gas, can now be monitored inside the housing and a dew-point temperature determined using a data-based dew-point model during a cold start phase. By comparing a threshold value of an ambient temperature, which is assumed to be the lowest possible temperature of a component in the active module, with a temperature threshold value that is defined depending on the dew-point temperature, excessive water ingress into the inside of the housing, e.g. due to a leak, can be determined.

It may be provided that the threshold value is above the maximum dew-point temperature by a predetermined temperature offset.

The threshold value may be the dew-point temperature plus an offset amount (tolerance amount).

For example, it may be assumed that the component that heats up last has a temperature corresponding to the ambient temperature. If a dew-point temperature that is less than a threshold value at the temperature of the component in question is estimated on the basis of the initial variations of the moisture level and temperature inside the housing, a corresponding error signal or warning can be signaled. The data-based dew-point model allows the storage capabilities of plastics, hygroscopic materials and the like inside the housing to be taken into account.

It may be provided that the data-based dew-point model is configured as a regression model that is configured in the form of a deep neural network or a recurrent neural network.

According to one embodiment, the data-based dew-point model may be trained on training datasets to associate one or more historical characteristics of the variations over time of the temperature and moisture level during an initial phase, which indicates a period of time at the beginning of the cold starting phase, with the maximum dew-point temperature expected to occur at a time within the entire cold starting phase. The initial phase can be, for example, a period of 1-5 minutes.

Alternatively, the data-based dew-point model may be trained as a recurrent model with training datasets to determine a predicted variation of the temperature and the moisture and to determine the maximum dew-point temperature from the predicted variation of the temperature and the moisture level.

The data-based dew-point model may be trained on the basis of measurement series in which the variation over time of the moisture level and temperatures are recorded for a specific active module starting from a point in time at which all components inside the housing have assumed the ambient temperature (cold starting). Training datasets result from the assignment of time series of the temperature and humidity after cold starting for the predetermined initial phase to a maximum of the variation of the dew-point temperature for a subsequent period of e.g. up to 30 minutes, preferably up to 15 minutes after the beginning of the cold starting phase, which corresponds to the remainder of the warm-up phase.

In addition, the measurement series may also take into account entries of different amounts of water into the inside of the housing to determine training datasets. Thus, by observing an initial variation over time of the temperature and moisture level inside the housing, after cold starting, a maximum dew-point temperature can be inferred, which will be reached during the warm-up phase of the active module.

By comparing the threshold value resulting from the maximum dew-point temperature taking into account a safety tolerance with the ambient temperature, it can be determined whether, within a warm-up phase of, for example, 1 to 30 min, in particular between 5 and 15 min, the case arises in which the slowest warming component inside the housing could cause condensation, i.e. condensation of water.

The data-based dew-point model may output a maximum dew-point temperature or, as a classification model, output an indication that there is a risk of condensation occurring on a component due to the temperature falling below a dew-point temperature.

### BRIEF DESCRIPTION OF THE DRAWINGS

Preferred embodiments are described in more detail below with reference to the accompanying drawings. The figures show:

FIG. 1 a schematic illustration of an active module in a closed housing;

FIG. 2 a flow chart describing a method for operating the active module for monitoring a critical amount of moisture inside the housing; and

FIG. 3 a flow chart illustrating a method for training a data-based dew-point model.

### DESCRIPTION OF EMBODIMENTS

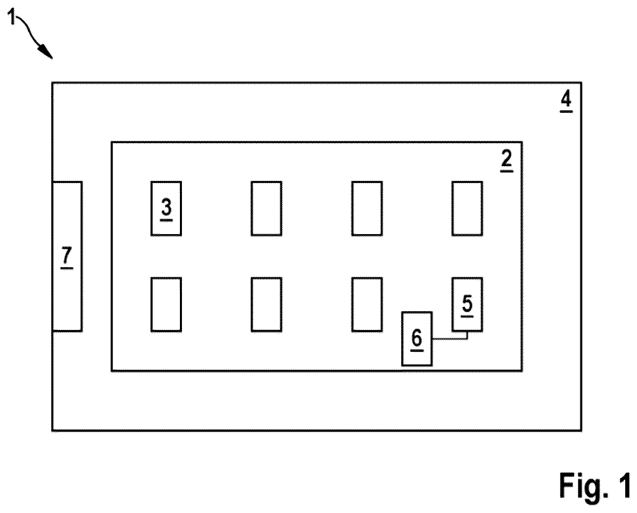

FIG. 1 shows a schematic cross-sectional diagram through an active module 1 having an electronic assembly. The active module 1 may be a control device having a control device printed circuit board 2 on which the electronic assembly is implemented. The control device printed circuit board 2 comprises an electronic circuit having components 3 that are powered upon activation. Different powers are implemented in the various components of the printed circuit board 2 upon activation, which can thus lead to different levels of heating.

The printed circuit board 2 is housed in a housing 4, which is closed moisture-proof. This protects the printed circuit board 2 and the components 3 of the electronic circuit on it from the effects of moisture and water.

The printed circuit board 2 or the electronic assembly further comprises a temperature/humidity sensor 5, which can be used to measure the temperature of the air or gas inside the housing 4 and its moisture level. The temperature/moisture sensor 5 may be configured as a combined sensor.

Using an evaluation unit 6, which carries out data processing implemented in software and/or hardware and which can also be configured on the printed circuit board 2 or separately thereof, the variation over time of the temperature and the moisture level can be recorded and evaluated and an alert signal can be generated upon detection of a critical state inside the housing 4.

The housing further comprises an interface 7, through which the active module 1 can be connected to an electrical supply source and via which it can communicate with external devices using electrical signals.

For example, the alert signal may be communicated via the interface to an external facility.

The evaluation unit 6 serves to evaluate the variations over time of the temperature and the moisture level after activation of the active module 1 during a cold starting phase. For the cold starting phase, it is initially assumed that all components of module 1 have a temperature corresponding to the ambient temperature. Once the module 1 is activated, a record of the variations over time of the temperature and the moisture level inside the housing 4 begins through the evaluation unit 6. These variations may be buffered or directly evaluated to determine a model output of a dew-point model implemented in the evaluation unit 6, e.g., in the form of a maximum dew-point temperature during the cold starting phase when the dew-point model is implemented as a data-based regression model. Alternatively, an indication of a critical state inside the active module 1 may be provided upon implementation of the data-based dew-point model as a classification model.

For example, an evaluation may be performed using a data-based dew-point model. This data-based dew-point model may extract historical characteristics from the variations over time of the temperature and moisture level and may be mapped to a maximum dew-point using the data-based dew-point model, which may be configured as, for example, a neural network or the like.

Alternatively, the data-based dew-point model may also be configured as LSTM (Long Short-term Memory) or as another recurrent data-based model that allows for predicting a variation of the dew-point inside the housing during the warm-up phase and storing the maximum value of the predicted path of the dew-point temperatures.

The evaluation unit 6 can further use a threshold comparison to determine whether a component, in particular the component that heats up the slowest, is at risk of condensation.

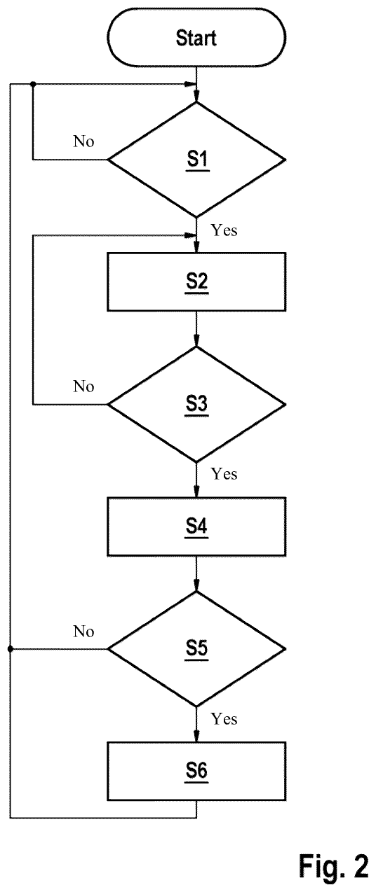

FIG. 2 schematically shows the method performed in the evaluation unit in the module using a flow chart.

In step S1, it is first checked whether the module has been activated for cold starting. Cold starting occurs when the module has not been activated for a predetermined period of time and it can be assumed that the components in the module 1 and its housing 4 are at ambient temperature.

If it is determined in step S1 that the module has been activated (alternative: Yes), then a record of the temperature and humidity values of the gas present in the housing 4 is started in step S2 and corresponding time series are temporarily stored. Furthermore, an ambient temperature may be detected separately or the first detected temperature value may be assumed as the ambient temperature. The temperature and moisture values are detected using the temperature and moisture sensor 5 on the printed circuit board 2 in the module 1. Otherwise (alternative: No), the method returns to step S1.

In step S3, it is checked whether a predetermined time has elapsed since the start of the recording corresponding to an initial phase. If this is the case (alternative: Yes), an evaluation of the time series is performed in step S4 to determine a maximum dew-point temperature. Otherwise the method returns to step S2.

The evaluation of step S4 is carried out using a data-based dew-point model, which allows a maximum dew-point temperature to be determined directly by regression or a maximum dew-point temperature from the end of the initial phase onward using a prediction of the variation over time of the dew-point temperature.

The data-based dew-point model may be configured as a deep neural network or a recurrent neural network, such as an LSTM or the like. In the case of a deep neural network, input vectors are extracted from input variables from the time series of the temperature and moisture level during the initial phase, one or more historical characteristics progression features, such as maximum, minimum and/or average gradients of temperature and the moisture level during the initial phase, maximum changes in temperature and moisture level during the initial phase, a dew-point temperature determined at the beginning of the cold starting phase from the temperature and humidity according to a predefined mathematical model or a predefined map, values of temperature and humidity at predefined times during the initial phase, maximum and minimum curvature of the variations of the temperature and the humidity level during the initial phase.

In the case of an LSTM, the time series of the temperature and the moisture are predetermined during the initial phase and after the initial phase the variations over time of the temperature and the moisture level of the gas present in the housing are predicted. A dew-point temperature results from the respective values of the temperature and the moisture level, so that a predicated dew-point temperature results for the time series up to the end of the cold starting phase. The maximum of the dew-point temperature may be determined from the predicted variation of the dew-point temperature.

In step S5, the ambient temperature is now used to check whether the ambient temperature is below a threshold amount depending on the maximum dew-point temperature, which can result, for example, from the maximum dew-point temperature plus a tolerance amount of, for example, between 1° C. and 3° C. It is assumed that the component that heats up most slowly is at an assumed temperature corresponding to the ambient temperature during the entire cold starting phase, which may correspond to a duration of between 5 minutes and 30 minutes. If this is the case (alternative: Yes), this is signaled accordingly in step S6, e.g. as a warning in the form of an error message externally to the module. Otherwise, the method is ended until re-activation is determined in the cold starting phase.

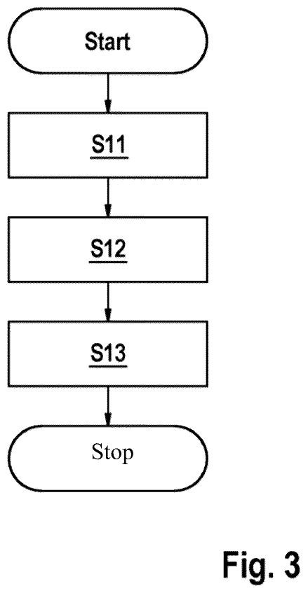

In FIG. 3, a flow chart for illustrating a training method for the data-based dew-point model is described. The data-based dew-point model may correspond to a deep neural network or other data-based model configured as a regression model. The data-based dew-point model may be trained on training records in a known manner, for example, using back-propagation and the like.

In step S11, an active module is measured at different ambient temperatures and different moisture contents inside the housing 4 for a defined period of time of the cold starting phase, e.g. 30 minutes. The measurement is made by recording time series of the temperature and the moisture during a cold starting phase, in each case starting from a module that has cooled down completely to ambient temperature. The time series are based on a sampling rate of, for example, between 1 second and 15 seconds.

In step S12, the training datasets are determined from the variations over time of the temperature and the moisture level during a cold starting phase of the active module 1 to be modeled. Input variables can be determined from the variations over time as historical characteristics of the variations over time of the temperature and the moisture level during the initial phase, as an example indicated above, as the input vector of a training dataset. The historical characteristics may thus result from a characteristic extraction of a variation over time of the temperature and the moisture level from an initial phase of the cold starting phase, for example a phase within the first three minutes.

The combinations of the temperature and the moisture level at each time of detection of the time series may each be associated with a dew-point temperature. From this, the maximum dew-point temperature can be determined as the label for the relevant training dataset.

Alternatively, the data-based dew-point model may also be configured as a recurrent neural network, such as an LSTM, which may be used to predict time series during the cold starting phase based on an initial time series or an initial value for the on switch-on state of the active model. By correspondingly evaluating the predicted time series, the maximum dew-point temperature can be found.

The recurrent neural network can be trained based on the time series of the temperature and the humidity level for the various measurements as training datasets.

After the training, in step S13, the data-based dew-point model can be implemented by transferring the parameters to the evaluation unit 6 in module 1.

1. A method for monitoring moisture level inside a closed housing of an active module, comprising:
after cold starting the active module, detecting a variation over time of a temperature and a moisture level of a gas inside the housing during a predetermined cold-starting phase;
providing an ambient temperature at the time of the cold starting of the active module; and
depending on the detected variations of the temperature and the moisture level and depending on the ambient temperature and with the aid of a data-based dew-point model provided, signaling an excessively high moisture level inside the housing wherein the data-based dew-point model is trained such that, depending on the variations of the temperature and the moisture level, it will give a maximum dew-point temperature or depending on an ambient temperature at the beginning of the cold-starting phase, it will give an indication of a possible instance of the temperature being below a maximum dew-point temperature.

2. The method according to claim 1, wherein signaling the excessively high moisture level inside the housing comprises:
determining the modeled maximum dew-point temperature during the cold-starting phase based on the variations of the temperature and the moisture level with the aid of the trained data-based dew-point model; and
signaling the excessively high level of moisture inside the housing if the ambient temperature is below a threshold value determined depending on the maximum dew-point temperature.

3. The method according to claim 1, wherein the temperature and the moisture level of the gas is determined with the aid of a combined moisture and temperature sensor.

4. The method according to claim 1, wherein the ambient temperature is provided as a temperature at the time of cold starting the active module by a temperature sensor inside or outside of the active module or as the first detected value of the temperature inside the housing.

5. The method according to claim 1, wherein the data-based dew-point model is configured as a regression model that is configured in the form of a deep neural network or a recurrent neural network.

6. The method according to claim 1, wherein the data-based dew-point model is trained with training datasets to associate one or more historical characteristics of the variation over time of the temperature and the moisture level during an initial phase of the maximum dew-point temperature throughout the cold starting phase.

7. The method according to claim 1, wherein the data-based dew-point model is trained as a recurrent model with training datasets to determine a predicted variation over time of the temperature and the moisture level based on the variation over time of the temperature and moisture level during the initial phase, and to determine the maximum dew-point temperature from the predicted variation of the temperature and the moisture level.

8. The method according to claim 1, wherein the threshold value is above the maximum dew-point temperature by a predetermined temperature offset.

9. A method for training a data-based dew-point model depending on training datasets, which assign an indication of a maximum dew-point temperature to variations of a temperature and a moisture level inside a housing of an active model or depending on an ambient temperature at the beginning of the cold-starting phase, an indication of a possible instance of a temperature being below a maximum dew-point temperature.

10. An evaluation unit for monitoring moisture level inside a closed housing of an active module, wherein the evaluation unit is configured for:
detecting a variation over time of a temperature and a moisture level of a gas inside the housing during a predetermined cold-starting phase after cold starting the active module;
providing an ambient temperature at the time of cold starting of the active module; and
depending on the detected variations of the temperature and the moisture level and depending on the ambient temperature and with the aid of a data-based dew-point model provided, signaling an excessively high moisture level inside the housing, wherein the data-based dew-point model is trained such that, depending on the variations of the temperature and the moisture level, it will give a maximum dew-point temperature or depending on an ambient temperature at the beginning of the cold-starting phase, it will give an indication of a possible instance of the temperature being below a maximum dew-point temperature.

11. A computer program comprising commands which, when the computer program is executed in a data processing device or a computer, cause the data processing device or computer to perform the method according to claim 1.

12. A machine-readable storage medium on which the computer program according to claim 11 is stored.
